(19) United States
(12) Patent Application Publication
(10) Pub. No.: US 2014/0282572 A1
(43) Pub. Date: Sep. 18, 2014

(54) TASK SCHEDULING WITH PRECEDENCE RELATIONSHIPS IN MULTICORE SYSTEMS

(71) Applicant: SAMSUNG ELECTRONICS CO., LTD., Suwon (KR)

(72) Inventor: Jaeyeon Kang, Cupertino, CA (US)

(73) Assignee: SAMSUNG ELECTRONICS CO., LTD., Suwon (KR)

(21) Appl. No.: 13/830,576

(22) Filed: Mar. 14, 2013

(51) Int. Cl. G06F 9/46

(52) U.S. Cl. CPC G06F 9/46
USPC 718/103

(57) ABSTRACT

A method for assigning tasks comprises receiving a set of tasks, modifying a deadline for each task based on execution ordering relationship of the tasks, ordering the tasks in increasing order based on the modified deadlines for the tasks, partitioning the ordered tasks using one of non-preemptive scheduling and preemptive scheduling based on a type of multicore processing environment, and assigning the partitioned tasks to one or more cores of a multicore electronic device based on results of the partitioning.

### TECHNICAL FIELD

One or more embodiments relate generally to task scheduling in multicore systems and, in particular, to task scheduling using precedence relationships in multicore systems.

### BACKGROUND

Real-time systems using multicore processors are employed in many diverse application areas including automotive electronics, avionics, space systems, control centers, communications systems, video conferencing, medical imaging, and consumer electronics. As multicore processors continue to scale, it has become possible to perform more complex and computation-intensive tasks in real-time. To fully exploit multicore processors, applications are expected to provide a large degree of parallelism where parallelizable real-time tasks can utilize multiple cores at the same time.

### SUMMARY

In one embodiment, a method provides assigning tasks. One embodiment comprises a method that comprises receiving a set of tasks. In one embodiment, a deadline for each task is modified based on execution ordering relationship of the tasks. In one embodiment, the tasks are ordered in increasing order based on the modified deadlines for the tasks. In one embodiment, the ordered tasks are partitioned using one of non-preemptive scheduling and preemptive scheduling based on a type of multicore processing environment. In one embodiment, the partitioned tasks are assigned to one or more cores of a multicore electronic device based on results of the partitioning.

Another embodiment provides an apparatus. In one embodiment, the apparatus comprises two or more processors, a local queue corresponding to each of the two or more processors and a partitioning module. In one embodiment, the partitioning module modifies a deadline for each task of a set of tasks based on execution ordering relationship of the tasks, orders the tasks in increasing order based on the modified deadlines for the tasks, and partitions the ordered tasks using one of non-preemptive scheduling and preemptive scheduling based on a type of processing environment. In one embodiment, a scheduling module assigns the partitioned tasks to the local queues based on results of the partitioning.

Another embodiment provides a non-transitory computer-readable medium having instructions which when executed on a computer perform a method comprising: receiving a set of tasks. In one embodiment, a deadline for each task is modified based on execution ordering relationship of the tasks. In one embodiment, the tasks are ordered in increasing order based on the modified deadlines for the tasks. In one embodiment, the ordered tasks are partitioned using one of non-preemptive scheduling and preemptive scheduling based on a type of multicore processing environment. In one embodiment, the partitioned tasks are assigned to one or more cores of a multicore electronic device based on results of the partitioning.

These and other aspects and advantages of the embodiments will become apparent from the following detailed description, which, when taken in conjunction with the drawings, illustrate by way of example the principles of the embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows a diagram of an architecture for task scheduling using precedence relationships in a multicore system, according to an embodiment.

FIG. 2 shows an example directed acrylic graph (DAG) and information for example tasks.

FIG. 3 shows an example comparison between task ordering for a first fit method combined with deadlines and an example of task scheduling using precedence relationships, according to an embodiment.

FIG. 4 shows an example schedulability graph depicting improvements using a dependent task partitioning (DTP) process for performance of methods for 1000 tasks and 3000 edges, according to an embodiment.

FIG. 5 shows an example schedulability graph depicting improvements using a DTP process for performance of methods for 1000 tasks and 7000 edges, according to an embodiment.

FIG. 6 shows an example time performance graph depicting improvements using a DTP process for performance of methods for 1000 tasks and 3000 edges, according to an embodiment.

FIG. 7 shows an example time performance graph depicting improvements using a DTP process for performance of methods for 1000 tasks and 7000 edges, according to an embodiment.

FIG. 8 shows an example energy performance graph depicting improvements using a DTP process for performance of methods for 1000 tasks and 3000 edges, according to an embodiment.

FIG. 9 shows an example energy performance graph depicting improvements using a DTP process for performance of methods for 1000 tasks and 7000 edges, according to an embodiment.

FIG. 10 shows an example scheduling runtime performance graph depicting improvements using a DTP process for performance of methods for 1000 tasks and 3000 edges, according to an embodiment.

FIG. 11 shows an example scheduling runtime performance graph depicting improvements using a DTP process for performance of methods for 1000 tasks and 7000 edges, according to an embodiment.

FIG. 12 shows an example schedulability performance graph depicting improvements using a DTP process with respect to number of edges/number of tasks, according to an embodiment.

FIG. 13 shows a DTP process for task scheduling using precedence relationships in a multicore system, according to an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

In accordance with one or more embodiments, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. One or more embodiments may also be tangibly embodied as a set of computer instructions stored on a computer readable medium, such as a memory device.

In one embodiment, scheduling is designed to support real-time and Quality-of-Service (QoS) requirements for tasks with precedence relationships (i.e., dependent tasks) on many/multicore systems. Most state-of-the-art solutions in multicore real-time scheduling focus on schedulability. However, as the number of cores increases, load balancing (i.e., effective distribution of real-time tasks to cores to exploit parallelism) is becoming an essential component of any scheduling solution that can effectively use resources without over-provisioning and wasting potential. Furthermore, the conventional methods are designed for independent tasks (i.e., tasks that can be executed in parallel without any precedence constraints). Techniques used to schedule independent tasks are not efficient for dependent tasks. One embodiment provides good schedulability (i.e., tasks may execute without missing deadlines) and, at the same time, provides performance improvement (i.e., time minimization) through effective task partitioning. In one embodiment, secondary effects include energy reduction since minimizing time generally leads to more slack to be allocated and finally reducing the energy requirements using dynamic voltage scaling (DVS). In one embodiment, timing constraints of tasks are transformed in directed acyclic graphs (DAGs) based on their precedence relationships, and a partitioning mechanism is applied that leads to good schedulability and load balancing (i.e., performance) while satisfying precedence constraints among tasks.

In one embodiment, a method assigns tasks in a multicore electronic device. One embodiment comprises receiving a set of tasks. In one embodiment, a deadline for each task is modified based on execution ordering relationship of the tasks. In one embodiment, the tasks are ordered in increasing order based on the modified deadlines for the tasks. In one embodiment, the ordered tasks are partitioned using one of non-preemptive scheduling and preemptive scheduling based on a type of multicore processing environment. In one embodiment, the partitioned tasks are assigned to one or more cores of the multicore electronic device based on results of the partitioning.

One or more embodiments support complex real-time applications (e.g., applications that exhibit inter-task relationships, such as partial ordering and data flow) and provides solutions for parallel programming languages (e.g., OpenMP®, Cilk™, X10). One embodiment achieves effective load balancing as well as good schedulability in multicore systems. In one embodiment, based on example results, the embodiments may execute real-time applications whose utilization is up to about 92% without missing task deadlines and may further reduce energy and time requirements for executing tasks up to about 74% and about 97%, respectively, compared to a conventional approach (i.e., first fit combined with increasing deadline-based task ordering (FFID)). In one embodiment, the performance is compatible to an optimal solution in terms of schedulability, energy, time requirements, with a reasonable scheduling runtime overhead (note that an optimal method requires large runtime, which may not be acceptable). In addition, one embodiment may be integrated seamlessly with existing operating systems (OS) schedulers using per-core run queues (e.g., Linux® 2.6, Windows Server® 2003, Solaris™ 10, FreeBSD® 5.2). In one embodiment, DTP may be efficiently applied in distributed systems so that tasks can be parallelized across distributed systems while executing tasks within deadlines.

FIG. 1 is a diagram illustrating an architecture for task scheduling using precedence relationships in a multicore system, in accordance with an embodiment. In one embodiment, a task set 100 is passed to a partitioning module 102. In one embodiment, the result of this partitioning is multiple portioned sets of tasks 104a-104c. In one embodiment, each of these sets of tasks 104a-104c is passed to a corresponding local queue 106a-106c, which is designated for corresponding cores 108a-108c. In one embodiment, each core 108a-108c has its own uniprocessor scheduler module 110a-110c, which schedules the tasks assigned to the corresponding core 108a-108c.

In general, the partitioning takes place prior to system runtime, while the individual cores apply their individual schedulers at runtime.

In one embodiment, the partitioning module 102 performs the following: task time constraint transformation, task ordering, and task partitioning. The overall procedure for this partitioning module 102 may be called “Dependent Task Partitioning” (DTP). The embodiments may be employed with an electronic device, which may include a cellular telephone, a personal e-mail or messaging device with audio and/or video capabilities, pocket-sized personal computers, such as an iPAQ™ Pocket PC available by Hewlett Packard Inc., of Palo Alto, Calif., personal digital assistants (PDAs), desktop computers, laptop computers, tablet computers, pad-type computing devices, a media players, and any other suitable device.

In one embodiment, task time constraint transformation transforms the time constraints of tasks (i.e., deadlines of tasks) based on their precedence relationships (i.e., tasks that have execution ordering relationships). In one embodiment, the deadlines of tasks are modified based on precedence constraints. The modified deadline implies that a task should finish by at least the modified deadline in order to satisfy deadline constraints. The deadline of each task is computed by traversing a DAG from an exit (i.e., a task with no successor). In one embodiment, the deadline of task tᵢ is defined by:

$${d}_{i}^{*} = min ( {d}_{i} , {min}_{{t}_{k} ∈ {succ}_{i}} ( {d}_{k}^{*} - {e}_{k} ) ) ,$$

where d*ᵢ is the deadline modified by considering precedence constraints for task tᵢ, dᵢ is the initial deadline of task tᵢ, eₖ is the execution time of task tₖ, and succᵢ is the set of immediate successors of task tᵢ. Here, if the initial deadline of a task is not specified, the initial deadline is assumed to equal to a specified deadline of an application including the task.

FIG. 2 shows an example DAG 210 and information 220 for example tasks that may take advantage of an embodiment. For this example, assume that the DAG consists of six tasks (i.e., t1, t2, t3, t4, t5, t6, t7), as shown in FIG. 2, and the tasks may be executed on two cores (i.e., processor 1 (P1), and processor 2 (P2), FIG. 3). In this example, the execution time of each task is 1, 1, 2, 2, 1, 2, and 2, respectively, and the deadline of the DAG is 6. For simplicity, it is assumed that there is no communication time in this example.

FIG. 3 shows an example comparison between task ordering for FFID 310 and an example of task scheduling using DTP 350, according to an embodiment. In the example, FIG. 3 shows the tasks 314 for FFID 310 assigned to P1 315a and P2 315b, and the tasks 360 for DTP 350 assigned to P1 365a and P2 365b. As illustrated, task t7 cannot be scheduled to meet the deadline in FFID 310. However, using DTP, tasks t1, t3, t5, and t7 are assigned to P1 365a and tasks t2, t4, and t6 are assigned to P2 365b. Using DTP, all tasks 360 may be executed within their deadlines. In this example, based on the precedence constraints among tasks, the deadline of each task can be modified using DTP as: 2, 2, 4, 4, 4, 6, and 6 for t1, t2, t3, t4, t5, t6, and t7, respectively.

In one embodiment, for task ordering, the partitioning module 102 (FIG. 1) sorts tasks by increasing order of deadlines of tasks. In one embodiment, if tasks have the same deadlines, these tasks are sorted by decreasing order of execution times to consider a critical task first. In one embodiment, once tasks are sorted by their modified deadlines, the tasks satisfy the precedence constraints. This task ordering list preserves precedence constraints among tasks of given DAGs. For the example in FIGS. 2 and 3, tasks 360 are sorted as follows: t1→t2→t3→t4→t5→t6→t7 (here tᵢ→tⱼ means that tᵢ has a higher priority than tⱼ for assignment).

In one embodiment, the partitioning module performs a task partitioning process, which is differently applied depending on whether scheduling requires preemption or non-preemption. In one embodiment, for an environment that preemption is not allowed or required, each task is assigned to the earliest core/processor where a task may start to execute while satisfying deadline constraints. In one embodiment, in the sorted order of tasks (i.e., ordered by increasing deadline), each task is assigned to the earliest core where it can start to execute while satisfying deadline constraints (i.e., earliest start time first). In one embodiment, the earliest start time of a task on a processor is computed by considering idle slots and precedence constraints given a partial schedule during assignment. In one embodiment, the ready time of a task on a core/processor is the time when all data needed by the task has arrived at the processor (i.e., time when all predecessors of the task has finished and all data from the predecessors has arrived at the processor) and the task is released. In one embodiment, the ready time of task tᵢ on processor pⱼ, rt(tᵢ,pⱼ), is defined by:

$$r t ( {t}_{i} , {p}_{j} ) = max \{ {r}_{i} , {max}_{{t}_{k} ∈ {pred}_{i}} ( {f}_{k} + {comm}_{ki} ) \} ,$$

where rᵢ is the release time (i.e., possible start time) for task tᵢ, predᵢ is the set of immediate predecessors of task tᵢ, fₖ is the finish time of task tₖ, and commₖᵢ is the communication time between tasks tₖ and tᵢ. For simplicity, note that there is no communication time when two tasks are assigned to the same processor.

In one embodiment, when assigning tasks to cores/processors, idle time slots, i.e. time slots between start time and finish time of two tasks that are consecutively scheduled on the same processor, are considered. In this embodiment, the earliest start time of a task on a processor is the earliest idle time slot that the task may be executed while satisfying the ready time of the task. In one embodiment, the search of an appropriate time slot starts at the ready time of the task and continues until finding the first idle time slot that is capable of holding the computation cost of the task. Based on the earliest start time for a task on cores/processors, the task is assigned to a core having the lowest earliest start time value. During this partitioning process, the partitioning module 102 performs a schedulability test that is applied to check if all deadline constraints are satisfied.

In one embodiment, for an environment that preemption is allowed or required in the sorted order of tasks (i.e., ordered by increasing deadline), each task is assigned by the partitioning module 102 to the earliest core where it can finish to execute while satisfying deadline constraints (i.e., earliest finish time first). In one embodiment, when preemption is allowed, the earliest start and finish time are differently computed since a task can start at an idle time after the ready time of the task with no need for the idle time to hold the computation cost of the task. Thus the earliest start time of a task on a processor is the earliest idle time that the task may be executed while satisfying the ready time of the task. In one embodiment, the earliest finish time is computed based on idle time slots from the earliest start time until the task finishes execution.

In one embodiment, the following represents pseudo code for DTP:

```
FUNCTION DTP (T, P)
  /* task time constraint transformation */
  Modify the deadlines of tasks by traversing a graph from
an exit task
  /* task ordering */
  Sort tasks in a task list, T, by increasing order of
modified deadlines of tasks
  - Break rule: sort tasks by decreasing order of
    execution times of tasks
  /* task partitioning */
  for each task, tᵢ, i <− 1 to n, tᵢ T do
    if preemption is allowed then
      Find a processor pⱼ (pⱼ P ) with the earliest start
time for the task tᵢ
    else
      Find a processor pⱼ (pⱼ P ) with the earliest finish
time for the task tᵢ
    end if
    if the task tᵢ is schedulable on the processor pⱼ then
      Assign the task tᵢ to the processor pⱼ
    else
      return partitioning_failed
    end if
  end for
  return task to processor assignment
end FUNCTION
```

In the example graphs shown in FIGS. 4-9, the degree of parallelism is a factor in the setup of deadlines of tasks: for example, deadline=sum of execution time of tasks/degree of parallelism, where 1≦degree of parallelism≦number of cores. When the degree of parallelism is 1, tasks may execute on only one core sequentially, but more parallel execution is required as the degree of parallelism increases.

FIG. 4 shows an example schedulability graph 400 depicting improvements using a dependent task partitioning (DTP) process for performance of methods for 1000 tasks and 3000 edges, according to an embodiment. In one example, DTP, according to one embodiment, is compared with FFID in terms of schedulability. The graph 400 shows the results for 1000 tasks with 3000 edges on 48 cores with respect to degree of parallelism.

FIG. 5 shows an example schedulability graph 500 depicting improvements using a DTP process for performance of methods for 1000 tasks and 7000 edges, according to an embodiment. The graph 500 shows the results for 1000 tasks with 7000 edges on 48 cores with respect to degree of parallelism. As shown in FIGS. 4 and 5 based on example experimental results, one embodiment using DTP improves schedulability by about 22 to about 63%, compared to FFID.

FIG. 6 shows an example time performance graph 600 depicting improvements using a DTP process for performance of methods for 1000 tasks and 3000 edges, according to an embodiment. In one example, DTP, according to one embodiment, is compared with FFID in terms of finish time. The graph 600 shows the results for 1000 tasks with 3000 edges on 48 cores with respect to degree of parallelism.

FIG. 7 shows an example time performance graph 700 depicting improvements using a DTP process for performance of methods for 1000 tasks and 7000 edges, according to an embodiment. The graph 700 shows the results for 1000 tasks with 7000 edges on 48 cores with respect to degree of parallelism. As shown in FIGS. 6 and 7 based on example experimental results, one embodiment using DTP improves finish time by up to about 97%, compared to FFID.

FIG. 8 shows an example energy performance graph 800 depicting improvements using a DTP process for performance of methods for 1000 tasks and 3000 edges, according to an embodiment. In one example, DTP, according to one embodiment, is compared with FFID in terms of finish time. The graph 800 shows the results for 1000 tasks with 3000 edges on 48 cores with respect to degree of parallelism.

FIG. 9 shows an example energy performance graph 900 depicting improvements using a DTP process for performance of methods for 1000 tasks and 7000 edges, according to an embodiment. The graph 900 shows the results for 1000 tasks with 7000 edges on 48 cores with respect to degree of parallelism. As shown in FIGS. 8 and 9 based on example experimental results, one embodiment using DTP improves energy performance by up to about 74% compared to FFID.

FIG. 10 shows an example scheduling runtime performance graph 1000 depicting improvements using a DTP process for performance of methods for 1000 tasks and 3000 edges, according to an embodiment. In one example, DTP, according to one embodiment, is compared with FFID in terms of finish time. The graph 800 shows the results for 1000 tasks with 3000 edges on 48 cores with respect to degree of parallelism.

FIG. 11 shows an example scheduling runtime performance graph 1100 depicting improvements using a DTP process for performance of methods for 1000 tasks and 7000 edges, according to an embodiment. The graph 900 shows the results for 1000 tasks with 7000 edges on 48 cores with respect to degree of parallelism. As shown in FIGS. 10 and 11 based on example experimental results, one embodiment using DTP improves scheduling runtime performance as compared to FFID.

FIG. 12 shows an example schedulability performance graph 1200 depicting improvements using a DTP process against another process with respect to number of edges/number of tasks, according to an embodiment. In one embodiment, graph 1200 shows the schedulability performance with respect to the ratio of the number of edges to the number of tasks (which represents the degree of parallelism of tasks—the larger ratio indicates more precedence constraints among tasks). As shown, using DTP according to one embodiment provides constant schedulability performance, while the schedulability performance of FFID becomes decreased as the ratio increases.

FIG. 13 shows a DTP process 1300 for task scheduling using precedence relationships in a multicore system, according to an embodiment. In one embodiment, process 1300 begins with block 1310 where a set of tasks are received (e.g., from an application, thread, etc.). In one embodiment, in block 1320 a deadline for each task is modified (e.g., by a partitioning module 102) based on execution ordering relationship of the tasks. In one embodiment, in block 1330, the tasks are ordered (e.g., sorted) in increasing order based on the modified deadlines for the tasks. In one embodiment, in block 1340, the ordered tasks are partitioned using non-preemptive scheduling or preemptive scheduling depending on a type of multicore processing environment (e.g., an environment type where preemptive scheduling is allowed or required or an environment type where preemptive scheduling is not allowed or not required). In one embodiment, in block 1350, the partitioned tasks are assigned to one or more cores of the multicore electronic device based on results of the partitioning.

One embodiment, supports tasks with precedence relationships (e.g., as defined by a task DAG), and is useful not only for hard real-time (e.g., safety/mission-critical) applications, but also for soft real-time, QoS-aware applications, such as multimedia stream processing. One embodiment, supports both good schedulability and good load balancing in multi-/many-core systems, reduces resource inefficiency and improves throughput in multicore systems. One embodiment makes many real-time applications schedulable even under tight deadline constraints, and may lead to better energy minimization. One or more embodiments support both preemptive and non-preemptive scheduling, depending on the scheduling environment.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multicore processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method for assigning tasks, the method comprising:
receiving a set of tasks;
modifying a deadline for each task based on execution ordering relationship of the tasks;
ordering the tasks in increasing order based on the modified deadlines for the tasks;
partitioning the ordered tasks using one of non-preemptive scheduling and preemptive scheduling based on a type of multicore processing environment; and
assigning the partitioned tasks to one or more cores of a multicore electronic device based on results of the partitioning.

2. The method of claim 1, wherein ordering the tasks in increasing order based on the modified deadlines for the tasks further comprises sorting by decreasing order of execution time upon determining two or more tasks have a same deadline.

3. The method of claim 1, wherein the type of multicore environment comprises one of a multicore environment that allows or requires preemption and a multicore environment where preemption is not required or not allowed.

4. The method of claim 3, wherein non-preemptive scheduling comprises:
assigning each task to a core having an earliest available start time for a task where a task starts to execute while satisfying a deadline constraint.

5. The method of claim 3, wherein preemptive scheduling comprises:
assigning each task to a core having an earliest available start time for a task where a task finishes to execute while satisfying a deadline constraint.

6. The method of claim 4, wherein the earliest start time for a task on a core is computed by considering idle slots and execution ordering relationship constraints given a partial schedule during assignment.

7. The method of claim 5, wherein the earliest start time for a task on a core is computed by considering idle slots and execution ordering relationship constraints given a partial schedule during assignment.

8. The method of claim 1, further comprising:
at each of the one or more cores assigned a partitioned task, after the assignment of the partitioned tasks, performing a uniprocessor scheduling algorithm on tasks assigned to the corresponding core.

9. An apparatus comprising:
two or more processors;
a local queue corresponding to each of the two or more processors;
a partitioning module that:
modifies a deadline for each task of a set of tasks based on execution ordering relationship of the tasks, orders the tasks in increasing order based on the modified deadlines for the tasks, and partitions the ordered tasks using one of non-preemptive scheduling and preemptive scheduling based on a type of processing environment; and
a scheduling module that assigns the partitioned tasks to the local queues based on results of the partitioning.

10. The apparatus of claim 9, further comprising a uniprocessor scheduling module corresponding to each of the two or more processors.

11. The apparatus of claim 10, wherein the uniprocessor scheduling module schedules tasks assigned to a corresponding local queue.

12. The apparatus of claim 11, wherein the tasks require assignment in near real-time.

13. The apparatus of claim 9, wherein ordering the tasks in increasing order based on the modified deadlines for the tasks further comprises the partitioning module sorting the tasks by decreasing order of execution time upon determining two or more tasks have a same deadline.

14. The apparatus of claim 13, wherein the type of processing environment comprises one of a processing environment that allows or requires preemption and a processing environment where preemption is not required or not allowed.

15. The apparatus of claim 14, wherein non-preemptive scheduling comprises the partitioning module assigning each task to a processor having an earliest available start time for a task where a task starts to execute while satisfying a deadline constraint.

16. The apparatus of claim 14, wherein preemptive scheduling comprises the partitioning module assigning each task to a processor having an earliest available start time for a task where a task finishes executing while satisfying a deadline constraint.

17. The apparatus of claim 15, wherein the earliest start time for a task on a processor is computed by considering idle slots and execution ordering relationship constraints given a partial schedule during assignment.

18. The apparatus of claim 15, wherein the earliest start time for a task on a processor is computed by considering idle slots and execution ordering relationship constraints given a partial schedule during assignment.

19. A non-transitory computer-readable medium having instructions which when executed on a computer perform a method comprising:
receiving a set of tasks;
modifying a deadline for each task based on execution ordering relationship of the tasks;
ordering the tasks in increasing order based on the modified deadlines for the tasks;
partitioning the ordered tasks using one of non-preemptive scheduling and preemptive scheduling based on a type of multicore processing environment; and
assigning the partitioned tasks to one or more cores of a multicore electronic device based on results of the partitioning.

20. The medium of claim 19, wherein ordering the tasks in increasing order based on the modified deadlines for the tasks further comprises sorting by decreasing order of execution time upon determining two or more tasks have a same deadline.

21. The medium of claim 20, wherein the type of multicore environment comprises one of a multicore environment that allows or requires preemption and a multicore environment where preemption is not required or not allowed.

22. The medium of claim 21, wherein non-preemptive scheduling comprises:
assigning each task to a core having an earliest available start time for a task where a task starts to execute while satisfying a deadline constraint.

23. The medium of claim 22, wherein preemptive scheduling comprises:
assigning each task to a core having an earliest available start time for a task where a task finishes executing while satisfying a deadline constraint.

24. The medium of claim 23, wherein the earliest start time for a task on a core is computed by considering idle slots and execution ordering relationship constraints given a partial schedule during assignment.

25. The medium of claim 23, wherein the earliest start time for a task on a core is computed by considering idle slots and execution ordering relationship constraints given a partial schedule during assignment.

26. The medium of claim 19, further comprising:
at each of the one or more cores assigned a partitioned task, after the assignment of the partitioned tasks, performing a uniprocessor scheduling algorithm on tasks assigned to the corresponding core.
